(19) United States
(12) Patent Application Publication
(10) Pub. No.: US 2019/0138996 A1
(43) Pub. Date: May 9, 2019

(54) Automated Intelligent Assistant for User Interface with Human Resources Computing System

(71) Applicant: SAP SE, Waldorf (DE)

(72) Inventors: Abhijit Salvi, Cupertino, CA (US); Anil Kumar Muddasani, Dublin, CA (US); David Ragones, Piedmont, CA (US); Gregory Squire, Palo Alto, CA (US); Dominic Philip Haine, Burlingame, CA (US)

(21) Appl. No.: 15/803,357

(22) Filed: Nov. 3, 2017

(51) Int. Cl. G06Q 10/10; G06Q 10/06; G06F 17/27; G10L 15/18

(52) U.S. Cl. CPC G06Q 10/105; G10L 15/1822; G06F 17/2705; G06Q 10/06

(57) ABSTRACT

An automated intelligent assistant receives user input including free-form text entered into a user interface (UI). The automated intelligent assistant can parse the free-form text to identify an intent of the user. The intent can be a request for employee data, employer data, and execution of tasks relating to employment of the employee by the employer. The automated intelligent assistant can deploy an extensible markup language (XML) file corresponding to the identified intent. The XML file can define a parameter and an application program interface (API) each required for implementation of that intent. The deploying can include the automated intelligent assistant prompting the user to enter the parameter defined by the XML file into the UI, calling the API defined by the XML file and passing the entered parameter thereto, and receiving an output from the API. The automated intelligent assistant can generate a response based on the API output.

### TECHNICAL FIELD

The subject matter described herein relates to user interfaces with computing systems.

### BACKGROUND

Computing systems for managing the data of an employer's employees can include databases storing many different types of employee and employer data, and can use several different types of applications to access that data. This can pose technological barriers to accessing employee or employer information and to processing employee and employer requests. For example, for a user such as the employee to request information about his or her own employee data, to request information about an employer policy, or to request the employer to execute a particular task relating to the employee's employment, the employee may need to select, access, and navigate various of the available applications, if such information or action can even be requested via such applications. If such information or action cannot be requested via such applications, or if the employee cannot figure out how to use the applications to obtain the information or request that the task be implemented, then the employee either may ask a manager or an individual in the human resources department of that employer for that information or task, or simply may give up on the request. To address the employee's request for the information or task, or to make his or her own such request, a user such as the manager or the individual in human resources similarly may need to select, access, and navigate various of the available applications, if such information or action can even be requested via such applications, and/or may need to ask someone else in human resources or elsewhere in the company.

### SUMMARY

An automated intelligent assistant for a user interface with a human resources computing system is provided herein.

Under one aspect, a method is provided that includes receiving, by an automated intelligent assistant operating on one or more data processors, first user input that can include free-form text entered into a user interface (UI) forming part of an end-user layer of a computer system. The method also can include parsing, by the automated intelligent assistant, the free-form text to identify an intent of the user. The intent can be selected from a group of pre-defined intents, wherein the group of pre-defined intents can include requests for employee data, requests for employer data, and requests for execution of tasks relating to employment of the employee by the employer. The method also can include deploying, by the automated intelligent assistant, an extensible markup language (XML) file corresponding to the identified intent. The XML file can define a parameter required for implementation of that intent and an application program interface (API) required for implementation of that intent. The deploying can include prompting, by the automated intelligent assistant, the user to enter the parameter defined by the XML file into the UI. The deploying also can include calling the API defined by the XML file. The deploying also can include passing the entered parameter to the called API. The deploying also can include receiving an output from the called API responsive to the entered parameter. The method also can include generating, by the automated intelligent assistant, a response to the identified intent of the user based on the output from the called API.

In some configurations, the parsing can include identifying a keyword in the free-form text that corresponds to the identified intent. In some configurations, the prompting can include conversationally posing a question to the user within the UI, and wherein the entered parameter can include free-form text. In some configurations, the prompting can include presenting to the user a plurality of choices within the UI, and wherein the entered parameter can include a selected one of the choices. In some configurations, the employee data and employer data are stored in one or more databases of the computer system. As a further option, the intent can include a request for employee data or employer data, and the API can extract the requested employee data or employer data from the one or more databases responsive to the entered parameter. In some configurations, the intent can include a request for execution of a task relating to employment of the employee by the employer, and the API executes the task responsive to the entered parameter.

Under another aspect, a computer system is provided that includes at least one data processor; and memory storing instructions which, when executed by the at least one data processor, result in operations. The operations can include receiving, by an automated intelligent assistant operating on one or more data processors, first user input that can include free-form text entered into a user interface (UI) forming part of an end-user layer of a computer system. The operations also can include parsing, by the automated intelligent assistant, the free-form text to identify an intent of the user. The intent can be selected from a group of pre-defined intents, wherein the group of pre-defined intents can include requests for employee data, requests for employer data, and requests for execution of tasks relating to employment of the employee by the employer. The operations also can include deploying, by the automated intelligent assistant, an extensible markup language (XML) file corresponding to the identified intent. The XML, file can define a parameter required for implementation of that intent and an application program interface (API) required for implementation of that intent. The deploying can include prompting, by the automated intelligent assistant, the user to enter the parameter defined by the XML file into the UI. The deploying also can include calling the API defined by the XML file. The deploying also can include passing the entered parameter to the called API. The deploying also can include receiving an output from the called API responsive to the entered parameter. The operations also can include generating, by the automated intelligent assistant, a response to the identified intent of the user based on the output from the called API.

In some configurations, the parsing can include identifying a keyword in the free-form text that corresponds to the identified intent. In some configurations, the prompting can include conversationally posing a question to the user within the UI, and wherein the entered parameter can include free-form text. In some configurations, the prompting can include presenting to the user a plurality of choices within the UI, and wherein the entered parameter can include a selected one of the choices. In some configurations, the employee data and employer data are stored in one or more databases of the computer system. As a further option, the intent can include a request for employee data or employer data, and the API extracts the requested employee data or employer data from the one or more databases responsive to the entered parameter. In some configurations, the intent can include a request for execution of a task relating to employment of the employee by the employer, and the API executes the task responsive to the entered parameter.

Under still another aspect, a non-transitory computer-readable medium is provided storing instructions which, when executed by at least one data processor of a computer system, result in operations. The operations can include receiving, by an automated intelligent assistant operating on one or more data processors, first user input that can include free-form text entered into a user interface (UI) forming part of an end-user layer of a computer system. The operations also can include parsing, by the automated intelligent assistant, the free-form text to identify an intent of the user. The intent can be selected from a group of pre-defined intents, wherein the group of pre-defined intents can include requests for employee data, requests for employer data, and requests for execution of tasks relating to employment of the employee by the employer. The operations also can include deploying, by the automated intelligent assistant, an extensible markup language (XML) file corresponding to the identified intent. The XML file can define a parameter required for implementation of that intent and an application program interface (API) required for implementation of that intent. The deploying can include prompting, by the automated intelligent assistant, the user to enter the parameter defined by the XML file into the UI. The deploying also can include calling the API defined by the XML file. The deploying also can include passing the entered parameter to the called API. The deploying also can include receiving an output from the called API responsive to the entered parameter. The deploying also can include generating, by the automated intelligent assistant, a response to the identified intent of the user based on the output from the called API.

In some configurations, the parsing can include identifying a keyword in the free-form text that corresponds to the identified intent. In some configurations, the prompting can include conversationally posing a question to the user within the UI, and wherein the entered parameter can include free-form text. In some configurations, the prompting can include presenting to the user a plurality of choices within the UI, and wherein the entered parameter can include a selected one of the choices. In some configurations, the employee data and employer data are stored in one or more databases of the computer system. The intent can include a request for employee data or employer data, and the API can extract the requested employee data or employer data from the one or more databases responsive to the entered parameter. In some configurations, the intent can include a request for execution of a task relating to employment of the employee by the employer, and the API can execute the task responsive to the entered parameter.

Non-transitory computer program products (i.e., physically embodied computer program products) are also described that store instructions, which when executed by one or more data processors of one or more computing systems, cause at least one data processor to perform operations herein. Similarly, computer systems are also described that can include one or more data processors and memory coupled to the one or more data processors. The memory can temporarily or permanently store instructions that cause at least one processor to perform one or more of the operations described herein. In addition, process flows can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the present subject matter can provide an automated intelligent assistant that provides a unified user interface to disparate applications and databases of a human resources computing system. The intelligent assistant is programmed so as to automatically respond to the requests of employees and individuals in a conversational manner, thus obviating the need for direct user interfaces to individual applications and databases of the human resources computing system.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating an example computer system for use in connection with the current subject matter.

FIG. 2 is an example process flow diagram for implementing an automated intelligent assistant for a user interface with a human resources computing system.

FIGS. 3A-3C illustrate nonlimiting examples of user interfaces with an automated intelligent assistant for a human resources computing system.

FIG. 4 is a diagram illustrating a sample computing device architecture for implementing various aspects described herein.

Like reference symbols in the various drawings indicate like elements.

### DETAILED DESCRIPTION

The systems, computer-readable media, and methods provided herein can provide an automated intelligent assistant for a user interface (UI) with a human resources computing system. The automated intelligent assistant can be configured so as to provide a conversational interface between the user, such as an employee, employer, manager, or individual in the human resources department of the employer, and application programming interfaces (APIs) and databases of the employer's computing system that access, store, and process employee and employer data. For example, the user can “chat” with the automated intelligent assistant in a similar manner as with another user, e.g., can type in a question and can receive an answer from the automated intelligent assistant in a dialog, and/or can request a task that the automated intelligent assistant can execute. The automated intelligent assistant can be implemented using a conversational description language (CDL) that is implemented in XML, and supports a wide variety of use cases, such as but not limited to those provided herein.

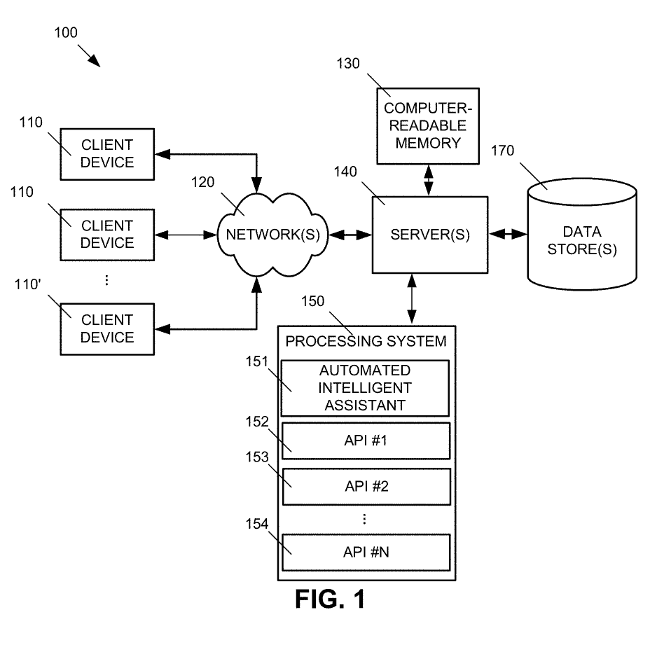

FIG. 1 is a system diagram illustrating an example computer system 100 for use in connection with the certain subject matter. System 100 can include at least one data processor, and memory storing instructions which, when executed by the at least one data processor, result in operations provided herein. In system 100, one or more client devices 110, 110′ within an end-user layer of system 100 can be configured to access one or more servers 140 running one or more automated intelligent assistants 151 and one or more APIs 152 . . . 154 on one or more processing systems 150 via one or more networks 120. Alternatively, one or more of client device 110 and server 140 can be the same computing device, eliminating the need for network 120. One or more servers 140 can access computer-readable memory 130 as well as one or more data stores 170.

System 100 can correspond to a human resources computing system, e.g., a computing system maintained by an employer and/or maintained by a third party on behalf of an employer, and can be configured so as to manage employee data, employer data, and implement different tasks associated with employment of the employees by the employer via automated intelligent assistant 150 in a manner such as provided herein. For example, in one exemplary configuration, one or more of client devices 110 corresponds to an employee node including a first UI via which a first user, such as an employee, can interact with automated intelligent assistant 151 so as to request employee data, request employer data, or request execution of tasks relating to employment of the employee by the employer, within system 100; one or more of client devices 110′ corresponds to an employer node including a second UI via which a second user, such as the employer, a manager of an employee, or individual in human resources of the company, can interact with automated intelligent assistant 151 so as to request employee data, request employer data, or request execution of tasks relating to employment of the employee by the employer, within system 100; and server(s) 140 correspond to a human resources hub including a processing system 150 configured to implement automated intelligent assistant 151 and APIs 152 . . . 154 and to interface with data store(s) 170 so as to respond to user input at a first UI at employee node 110 and/or at a second UI at employer node 110′.

Client device(s) 110 and 110′ (e.g., employee nodes and employer nodes) each can include, for example, a respective central processing unit and a computer-readable medium storing instructions for causing the respective central processing unit to perform one or more operations such as provided herein. For example, a computer-readable medium can store instructions causing the central processing unit of client device(s) 110, 110′ to receive user input and to interface with automated intelligent assistant 151 for responding to such input in an easy to use manner that can obviate the need for client devices 110, 110′ to separately interact with one or more of APIs 152 . . . 154 or with data store(s) 170 so as to request employee data, employer data, and/or request execution of tasks relating to employment of the employee by the employer.

Server(s) 140 can be configured so as to use automated intelligent assistant 151 to receive user input received by the UIs of client device(s) 110, 110′; to parse the free-form text to identify an intent of the user; and to deploy an extensible markup language (XML) file corresponding to the identified intent. Such operations can be implemented by automated intelligent assistant 151. The XML file can define a parameter required for implementation of that intent and an API (e.g., one or more of APIs 152 . . . 154) required for implementation of that intent. The deploying can include prompting the user to enter the parameter defined by the XML file into the UI (e.g., of employee node 110 or employer node 110′); calling the API defined by the XML file; passing the entered parameter to the called API; and receiving an output from the called API responsive to the entered parameter. Server(s) 140 (e.g., automated intelligent assistant 151 operating on processing system 150) can be configured so as to generate a response to the identified intent of the user based on the output from the called API. The intent can selected from a group of pre-defined intents, such as requests for employee data, requests for employer data, and requests for execution of tasks relating to employment of the employee by the employer. For example, human resources hub 140 can be configured so as to provide user input received from client devices 110, 110′ to processing system 150 for processing by automated intelligent assistant 151, which in turn interacts with APIs 152 . . . 154 and/or data stores 170 in a manner such as described in greater detail herein. Illustratively, processing system 150 can include a central processing unit and a computer-readable medium storing instructions (e.g., automated intelligent assistant 151 and APIs 152 . . . 154) for causing the central processing unit to perform one or more operations such as provided herein.

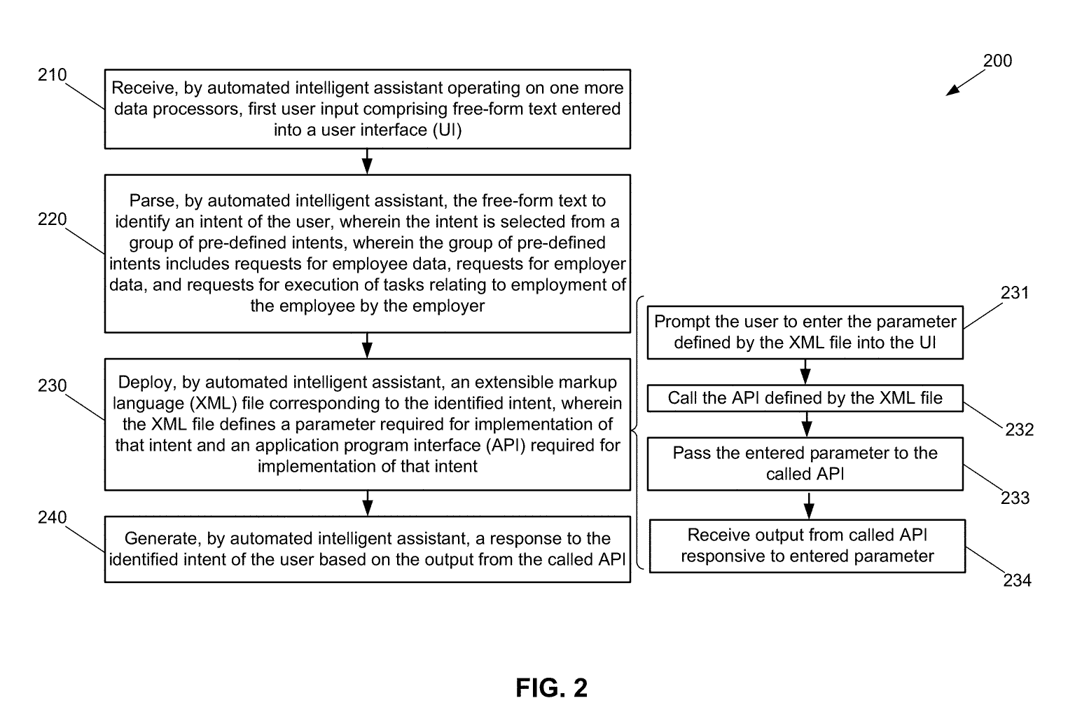

FIG. 2 is an example process flow diagram 200 for implementing an automated intelligent assistant for a user interface with a human resources computing system. Although operations performed during implementation of process flow diagram 200 are described with reference to certain components of system 100 illustrated in FIG. 1, it should be appreciated that any of such operations suitably can be performed using any suitable combination of computer hardware and/or software components.

Process flow diagram 200 illustrated in FIG. 2 includes an operation of receiving, by an automated intelligent assistant operating on one or more data processors, first user input comprising free-form text entered into a UI forming part of an end-user layer of a computer system (operation 210). For example, automated intelligent assistant 151 illustrated in FIG. 1 can operate on one or more data processors of processing system 150, and can be configured so as to receive free-form text or other user input entered by an employee into client device 110 or entered by an employer into client device 110′. Such user input can be received at client device 110 or 110′ and transmitted to automated intelligent assistant 151 via network(s) 120 and server(s) 140. The free-form text can relate to employee or employer data or a task relating to employment of the employee by the employer, and need not have any particular format. For example, the free-form text can be in the form of a question, such as “How many days can I take off?” or “Can I enroll in a course?” or “Can I schedule a vacation?” or can be in the form of a statement, such as “Number of vacation days remaining” or “Course availability” or “Schedule vacation time.”

Some non-limiting examples of questions or statements that the automated intelligent assistant 151 can receive include simple, basic day-to-day questions; requests for information about newly published company processes such as stock option programs, semi-retirement programs, new regulations, or company car regulations; leave questions, such as how many entitlements for which an employee is eligible; payment questions, such as if an overtime payment appears incorrect; and general questions related to country-specific benefits; requests for information about newly published HR processes such as new company regulation, new leave regulations, changes related to available benefits, recurring processes with time lines; leave entitlement expiration; requests for information about open benefit enrollment periods during which employees typically must choose an insurance policy; requests for information about benefits, such as when the employee can change his or her benefits plan, what should an employee consider when planning a surgery (e.g., whether and how much sick leave is available and whether the sick leave must be used up before another type of leave becomes available), requests for information about information about what an employee needs to do to obtain a pension loan, whether an employee loses pension time when on leave of absence, and/or a list of doctors who are in-network in the employee's insurance policy; requests for information about information about how the employee can apply for a leave of absence (e.g., who needs to approve it or whether the leave may have an impact on the employee's seniority or salary); requests for guidance with insurance and general process if the employee had an accident while working; requests for information about who the employee should talk to in certain circumstances, e.g., if the employee considers his or her job duties to be inconsistent with job description; training and development, such as where can the employee find out about upcoming training programs (courses); and requests for information about how to change the employee's name and/or address. Other nonlimiting examples of questions and statements that can be entered into the UI in the form of free-form text, and received by automated intelligent assistant 151 for processing, are provided elsewhere herein.

Process flow diagram 200 illustrated in FIG. 2 includes an operation of parsing, by the automated intelligent assistant, the free-form text to identify an intent of the user (operation 220). The intent can be selected from a group of pre-defined intents that can be stored, for example, within data store(s) 170 and/or within computer-readable memory 130, and accessed by automated intelligent assistant 151 illustrated in FIG. 1. In some configurations, automated intelligent assistant 151 can be configured so as to identify the intent of the user by identifying one or more keywords in the free-form text that corresponds to the identified intent. For example, data store(s) 170 and/or computer-readable memory 130 can store a look-up table or database that stores keywords or combinations of keywords such as may be identified by parsing the free-form text (e.g., keywords such as “vacation” or “insurance,” or combinations of keywords such as “schedule vacation” or “insurance benefits”), and pre-defined intents that correspond to those keywords or combination of keywords (e.g., intents such as “request by employee for vacation time” or “request by employee for information about insurance benefits”). Automated intelligent assistant 151 can be configured so as to identify the intent of the user by comparing words of the freeform text to words in the look-up table or database, and for a word of the freeform text that matches a word in the look-up table or database (which word can be referred to as a “keyword,”), obtaining from the look-up table or database the intent corresponding to that word.

In other exemplary configurations, automated intelligent assistant 151 can be configured so as to identify the intent of the user using natural language processing.

The group of pre-defined intents (from which the automated intelligent assistant 151 can select the intent of the user based upon parsing of the free-form text) can include, for example, requests for employee data, requests for employer data, and requests for execution of tasks relating to employment of the employee by the employer. Employee data within the group of pre-defined intents can include, for example, employee head counts (which can be broken down by gender and/or location), employee demographics (such as employee gender, family status, and/or address), employee locations (e.g., primary workplace and any secondary workplaces), employee title and/or status within the company (e.g., data regarding any other employees to which the employee reports and/or who report to the employee), employee compensation information (e.g., present compensation, any previous compensation, any deductions from the employee's compensation, any bonuses), employee date(s) of employment (e.g., start date and/or, for employees no longer with the company, end date), benefit status (e.g., which insurance plan(s) or other employee benefits the employee is using and which family members are covered), employee leave status (e.g., a record of any vacation days the employee has used, is using, or plans to use, a number of vacation days the employee may have accrued, and/or data regarding any other leave that the employee may have taken, be taking, or plan to take), and/or a record of any employee education courses taken.

Employer data within the group of pre-defined intents can include, for example, employer policies regarding insurance benefits (e.g., available insurance policies from which employees can select and costs thereof, dates of open enrollment periods for employee enrollment in available insurance policies, and/or definitions of qualifying events based upon which an employee can enroll in an available insurance policy), emergency contact information, eligibility for employee bonuses (e.g., amounts and types of monetary or other non-salary awards for which an employee is eligible to receive or to award to another employee), eligibility for employee compensation (e.g., salary and any raises for which an employee may be eligible), employee education course information (e.g., a listing of employee education courses, any prerequisites for such courses, and/or any course prerequisites for an employee title).

Within the group of pre-defined intents, tasks associated with employment of the employees by the employer can include, for example, modification of employee enrollment in insurance policies (e.g., adding a family member to an insurance policy, removing a family member from an insurance policy), requesting or approving an employee leave (e.g., particular requested vacation days or another type of employee leave), requesting or approving an employee bonus (e.g., a monetary or other award for which an employee is eligible to receive or to award to another employee), requesting or approving an employee raise, requesting or approving employee enrollment in an employee education course, requesting or approving an employee promotion to another title, requesting or approving transition of an employee to report to another employee or to have another employee report to him or her.

Process flow diagram 200 illustrated in FIG. 2 includes an operation of deploying, by the automated intelligent assistant, an XML file corresponding to the identified intent (230). For example, a plurality of XML files respectively corresponding to the intents of the group of pre-defined intents can be stored, for example, within data store(s) 170 and/or within computer-readable memory 130, and accessed by automated intelligent assistant 151 illustrated in FIG. 1. In some configurations, automated intelligent assistant 151 can be configured so as to obtain the XML file that corresponds to the intent identified in operation 220, and to execute the XML file. Illustratively, pointers to the XML files that respectively correspond to intents can be stored in the look up table or database such that the automated intelligent assistant 151 readily can obtain and deploy (execute) the XML files during instances of operation 230.

In some configurations, the XML file defines a parameter required for implementation of that intent and/or an API required for implementation of that intent. For example, some requests for employee data or employee data or for execution of a task, e.g., as specified by the identified intent of the user, may need additional information before they can be fulfilled, and this additional information can be implemented in the form of a parameter defined within the XML file. Additionally, or alternatively, some requests for some requests for employee data or employee data or for execution of a task, e.g., as specified by the identified intent of the user, may need to be implemented using one or more of APIs 152 . . . 154 running on processing system 150 such as described herein with reference to FIG. 1. For example, system 100 illustrated in FIG. 1 can include databases storing many different types of employee and employer data, and can use several different types of APIs to store, retrieve, modify, or use that data. So as to obviate the need for an employee or employer to individually use such APIs, the automated intelligent assistant 151 can use the deployed XML file so as to call any APIs as appropriate and pass any required parameters thereto, and can obtain such parameters from the user as appropriate.

For example, in the non-limiting process flow illustrated in FIG. 2, operation 230 can include an operation of prompting, by the automated intelligent assistant, the user to enter the parameter defined by the XML file into the UI (operation 231). The prompting can include conversationally posing a question to the user within the UI, and the entered parameter can include free-form text. Alternatively, the prompting can include presenting to the user a plurality of choices within the UI, and the entered parameter can include a selected one of the choices; for example, a parameter can be of type “collection,” responsive to which a set of objects can be presented within the UI from which the user can select, e.g., by clicking. Operation 230 also can include an operation of calling the API defined by the XML, file (operation 232); an operation of passing the entered parameter to the called API (operation 233); and an operation of receiving an output from the called API responsive to the entered parameter (operation 234). Process flow 200 also can include generating, by the automated intelligent assistant, a response to the identified intent of the user based on the output from the called API (operation 240).

Illustratively, a non-limiting example of an XML file corresponding to a request for execution of a task corresponding to paying a monetary bonus (which can be referred to as a “SpotAward” to an employee who reports to the user is the following:

```
  <Intents>
    <Intent id=”SpotAward”>
      <RequiredParam id=”amount”>
        <language id=”en-us”>How much do you want to give as an
award?
        </language>
      </RequiredParam>
  <OptionalParam id=”reason”>
        <language id=”en-us”>What is the reason for this award?
        </language>
      </ OptionalParam>
      <TargetODATACall>/odata/AwardSpotBonus</TargetODATACall>
    </Intent>
  <Intents>
```

In the above example, SpotAward is the user intent, and the XML file corresponding to this intent defines a required parameter of amount and an optional parameter of reason, along with the description of the questions that are to be asked in a specific, conversational language. In this example, the amount and reason can be entered as free-form text. While deploying the XML file, the automated intelligent assistant 151 keeps asking questions within the UI of client device 110 or 110′ so as to prompt the user to enter the required parameter and any optional parameters, until all parameters are filled for that intent. Once all the information is fulfilled for the intent call, the automated intelligent assistant 151 calls an appropriate API 152 . . . 154, in this example an ODATA API, to execute the task corresponding to the intent of the user, e.g., awarding a SpotAward in the amount entered by the user and annotated with any reason that may have been entered by the user.

It should be appreciated that system 100 can store a wide variety of XML files for deployment by automated intelligent assistant 151 responsive to respective user input at client devices 110, 110′ so as to significantly simplify and enhance the user's interaction with different aspects of system 100. For example, a wide variety of types of employee data and employer data can be stored in one or more databases of the computer system, and indeed can be stored in databases that respectively are located in different work sites, off site, or even managed by a third party. In examples in which the intent includes a request for employee data or employer data, the API can extract the requested employee data or employer data from the one or more databases responsive to the parameter entered by the user responsive to prompting by the automated intelligent assistant, thus obviating the need for the user to access the API directly, let alone to know how to request the employee data or employer data from that API or to input any needed parameters into that API in association with that request. In examples in which the intent includes a request for execution of a task relating to employment of the employee by the employer, the API can execute the task responsive to the parameter entered by the user responsive to prompting by the automated intelligent assistant, thus obviating the need for the user to access the API directly, let alone to know how to request that API to execute the task or to input any needed parameters into that API in association with that request. XML files readily can be designed and stored within system 100 corresponding to any anticipated user intent. The automated intelligent assistant can be configured so as to deploy different XML files at appropriate times responsive to different user inputs, thus providing a seamless transition for the user between different types of requests that may use unrelated APIs.

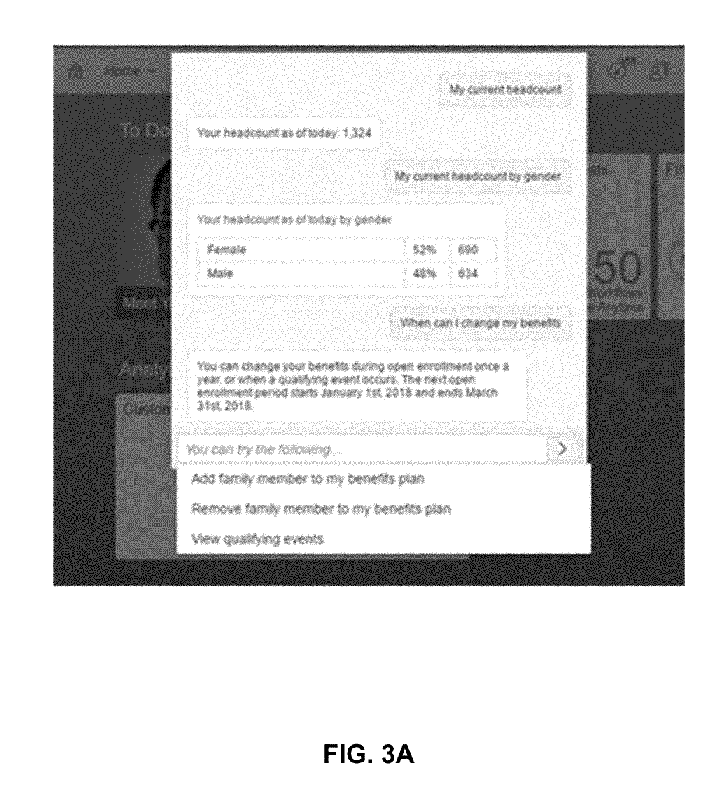

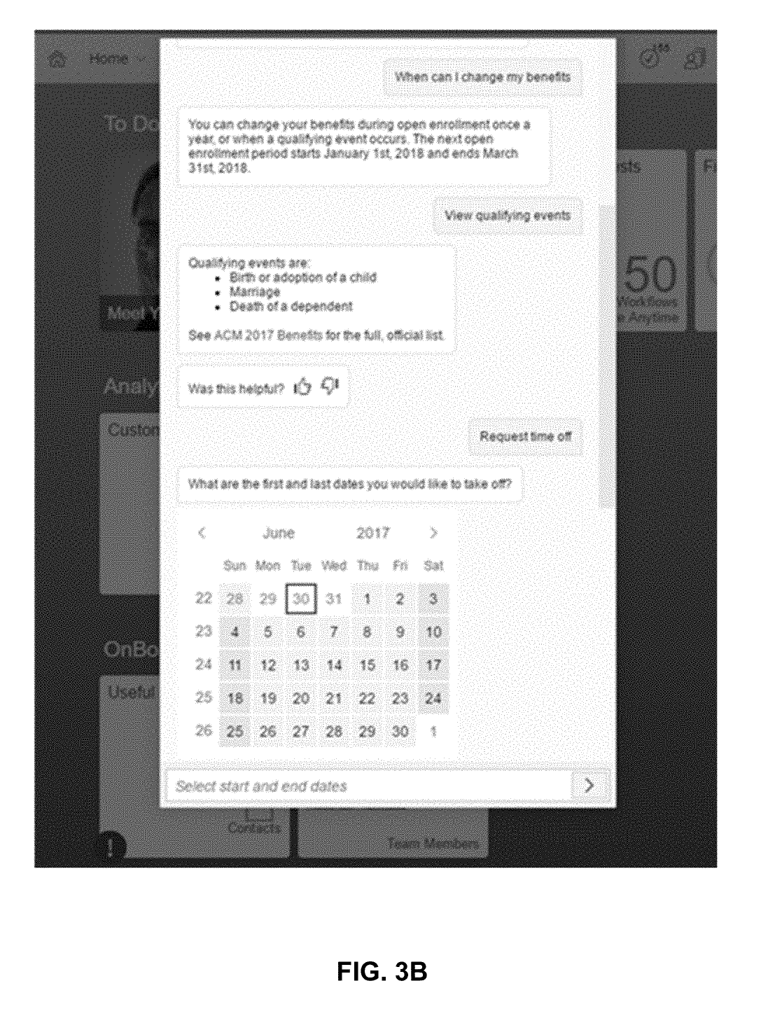

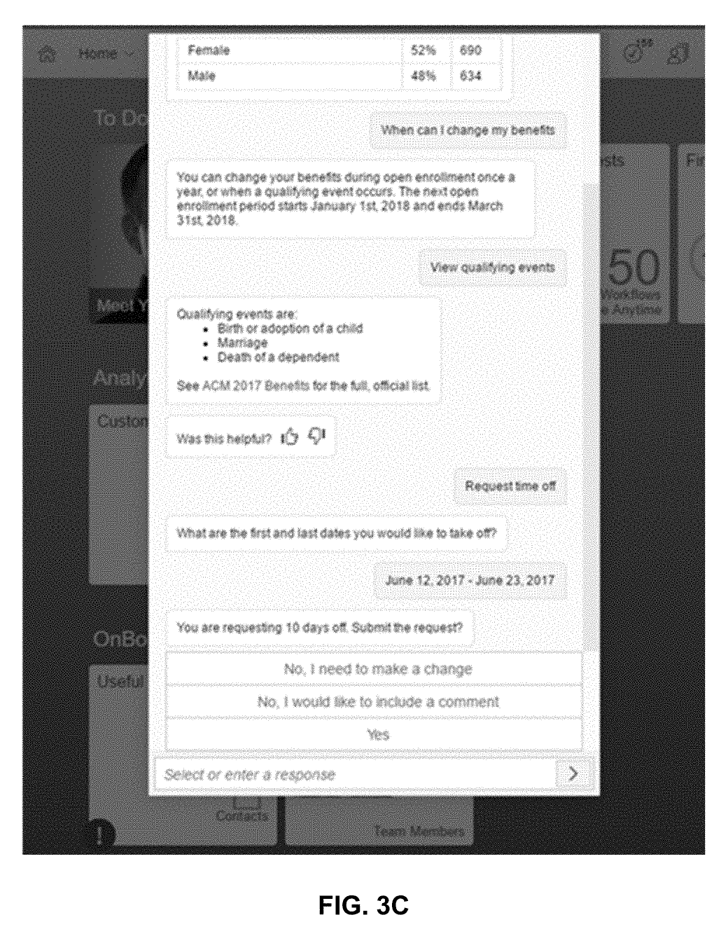

For example, FIGS. 3A-3C illustrate nonlimiting examples of UIs with an automated intelligent assistant for a human resources computing system. The UIs illustrated in FIGS. 3A-3C illustrate exemplary input to client device 110 or 110′ by a user (on the right hand side of the dialog), and exemplary responses by automated intelligent agent 151 (on the left hand side of the dialog) while implementing operations of method 200 responsive to such input based on an XML file. In FIG. 3A, responsive to the user input statement “My current headcount,” automated intelligent assistant 151 identified the user intent as being to request employee data about the number of employees currently employed by the employer (operation 220), deployed the XML file associated with that intent (operation 230) so as to obtain the employee data from an appropriate database of system 100 using an appropriate API of system 100, and generated the response “Your headcount as of today: 1,324” (operation 240). Also in FIG. 3A, responsive to the user input statement “My current headcount by gender,” automated intelligent assistant 151 identified the user intent as being to request employee data about the number of employees currently employed by the employer broken down by gender (operation 220), deployed the XML file associated with that intent (operation 230) so as to obtain the employee data from an appropriate database of system 100 using an appropriate API of system 100, and generated the response illustrated in FIG. 3A relating to the headcount by gender (operation 240).

Also in FIG. 3A, responsive to the user input question “When can I change my benefits,” automated intelligent assistant 151 identified the user intent as being to request employer data about the open enrollment period of the employer (operation 220), deployed the XML file associated with that intent (operation 230) so as to obtain the open enrollment period information from an appropriate database of system 100 using an appropriate API of system 100, and generated the response illustrated in FIG. 3A relating to the open enrollment period (operation 240). Additionally, in FIG. 3A, based on the deployed XML file the automated intelligent assistant 151 presents to the user within the UI a plurality of choices relating to possible changes to the benefits plan, such as “Add family member to my benefits plan,” “Remove family member to my benefits plan,” and “View qualifying events” (operation 231). As shown in FIG. 3B, the user selected “View qualifying events,” responsive to which the automated intelligent assistant 151 displays a list of qualifying events and a link to further information about the employer's policies regarding qualifying events (operation 240).

As also shown in FIG. 3B, responsive to the user input statement “Request time off,” automated intelligent assistant 151 identified the user intent as being to request a vacation (operation 220), deployed the XML file associated with that intent (operation 230) so as to conversationally request and obtain start and end dates (required parameters) from the user, prompt the user to confirm by selecting whether the request should be submitted, and responsive to the user input storing the request within an appropriate database of system 100 using an appropriate API of system 100 (operation 240). Thus, it can be understood from the examples shown in FIGS. 3A-3C that the automated intelligent assistant 151 readily can transition between deploying XML files respectively relating to disparate intents for requests for employee data (as exemplified by different types of headcounts), requests for employer data (as exemplified by insurance benefit information), and requests for execution of tasks relating to employment of the employee by the employer (as exemplified by scheduling of vacation time for the employee).

Accordingly, system 100 can include at least one data processor (e.g., processor(s) of client devices 110, 110′ and processing system 150) and memory (e.g., non-transitory computer-readable media of client devices 110, 110′ and processing system 150) storing instructions which, when executed by the at least one data processor, result in operations including receiving, by an automated intelligent assistant operating on one or more data processors, first user input comprising free-form text entered into a user interface (UI) forming part of an end-user layer of a computer system. The operations also can include parsing, by the automated intelligent assistant, the free-form text to identify an intent of the user. The intent can be selected from a group of pre-defined intents that includes requests for employee data, requests for employer data, and requests for execution of tasks relating to employment of the employee by the employer. The operations also can include deploying, by the automated intelligent assistant, an XML file corresponding to the identified intent. The XML file can defines a parameter required for implementation of that intent and an application program interface (API) required for implementation of that intent. The deploying can include prompting, by the automated intelligent assistant, the user to enter the parameter defined by the XML file into the UI; calling the API defined by the XML file; passing the entered parameter to the called API; and receiving an output from the called API responsive to the entered parameter. The operations also can include generating, by the automated intelligent assistant, a response to the identified intent of the user based on the output from the called API.

Accordingly, among other things, the present systems, methods, and computer-readable media provide an end-user layer that assists users with performing tasks and requesting information within a human resources computing system. Such tasks and requests can be implemented via a UI with an automated intelligent assistant that interacts appropriately with different databases and APIs based upon XML files for different user intents, that can make user interactions with the system easier, faster, and more interactive. The user can be more engaged with the system due to the conversational nature of the automated intelligent assistant, and the assistant can help the user perform tasks and make requests that would be more computationally complex or time consuming without the assistant.

### EXAMPLES

The following section provides exemplary use cases for the present automated intelligent assistant, e.g., exemplary conversations that users can have with the automated intelligent assistant based on corresponding XML files. The automated intelligent assistant can be configured so as to assist the user (here, an employee called “Amy” or “employee” or an employer called “Carla” or “manager”) in performing tasks or actions on the system. These can include, for example, tasks that the user can do on the system using the UI or APIs and the intelligent assistant (here, called “sfbot” or “chat assistant”) can implement these tasks in an easier, faster, and more interactive manner than if the user were to directly interact with the API. This could engage the user differently from the UI due to the conversational nature and also could help with doing tasks that would be more complex or time consuming without the assistant.

A. Performing Tasks in the System
(a) Example employee use case for enrolling in or taking “ToDo” course made available by employer

@Amy: ToDos

@sfbot: Hi Amy, You have 2 Instructor Led Trainings due this month, do you want to enroll for the next open Classroom Sessions for them?

[Enroll for “ILT-001”] [Enroll for “ILT-002”] [Enroll for all pending ILTs] [Later] (Buttons)

@Amy: Button pressed—Enroll for all pending ILTs

@sfbot: You are enrolled into the upcoming sessions.

@sfbot: There is also 1 online course due and 1 Survey, you can catch up in 30 minutes. Do you want to launch the course now?

[Launch Course] [Launch Survey] [Later] (Buttons)

@Amy: Button pressed—Launch Course

@sfbot: Launches Course (Action)
(b) Example employee use case for topic search for “ToDo” courses, such as “Analytics” course

@Amy: I want to learn about Analytics.

@sfbot: “Analytics Simplified” is the highest rated and most popular course on Analytics. You can

[Add to Learning Plan] [Launch Course Now] [View Details] [Show more courses] (Buttons)

@Amy: Button Clicked—Add to Learning Plan

@sfbot: This has a few unmet pre-requisites, do you want to add them to your learning Plan as well?

[Add unmet Pre-requisites] [Will review Later] (Buttons)

@Amy: Button Clicked—Add unmet Pre-requisites

@sfbot: All the pre-requisites are added to your learning plan

@sfbot: There are some open Instructor Led sessions later this month for the courses that you just added, do you want to enroll into them?

[Enroll into the earliest Sessions] [Enroll for next Month] [Later]

@Amy: Button pressed—Enroll into the earliest Sessions

@sfbot: You are enrolled into the Sessions starting next Wednesday. The last course requires an approval and the approval request is sent to your manager.
(c) Example employee use case for changing enrollment in “ToDo” courses based on leave or schedule conflicts

@Amy: ToDos

@sfbot: Hi Amy, You are on leave next Wednesday (Actual Date) and will not be able to attend ILT-001 scheduled next Wednesday, do you want to withdraw from the course today to minimize cancellation fees? You can enroll for the next open session that is scheduled for Friday.

[Withdraw from “ILT-001” on <Date>] [Withdraw from “ILT-001” and enroll into next open session] [Later]

@Amy: Button pressed: [Withdraw from “ILT-001” and enroll into next open session]

@sfbot: You are withdrawn from ILT-001 scheduled on Wednesday (Date) and enrolled for the session on Friday (Date)

@sfbot: As ILT-001 is a pre-requisite for ILT-002 you need to change your enrollment for ILT-002 from next Thursday (Date) to a later session after you attend ILT-001. Do you want to change your enrollment?

[Withdraw from “ILT-002” on <Date> and enroll into next open session][Later]

@Amy: Button Pressed—Withdraw from “ILT-002” on <Date> and enroll into next open session

@sfbot: Your registration for ILT-002 has been withdrawn on <Date> and you are enrolled in the next session on <new Date>
(d) Example employee use case for finding “ToDo” courses

@Amy: Recommend trainings related to goals

@sfbot: Here is a list of top 5 courses related to your goals that are not on your learning plan

<Course name, course duration, course rating> [Add to Learning Plan] . . .

<Course name, course duration, course rating> [Add to Learning Plan]

[Add all to learning Plan]

@Amy: Button pressed—Add all to Learning Plan

@sfbot: These courses are added to your learning plan with appropriate due dates. There are some unmet pre-requisites, would you like to add them as well?

[Add unmet pre-requisites to Learning Plan] [Later]

@Amy: Button pressed—Add unmet pre-requisites to Learning Plan

@sfbot: All unmet pre-requisites are also added to your Learning Plan.

@sfbot: Would you like to enroll into the available Classroom sessions for these courses within the due dates

[Enroll into Classroom Sessions] [Later]

@Amy: Button pressed—Enroll into Classroom Sessions

@sfbot: You have been enrolled into the earliest classroom sessions in order of pre-requisites and within the required dates.

<List of enrollments and Dates>
(e) Example employee use case for finding “ToDo” courses based on internal job applications

@Amy: Trainings related to my job application

@sfbot: Here is a list of top 2 courses related to your recent Job Application

<Course name, course duration, course rating> [Add to Learning Plan] [Launch Course]

<Course name, course duration, course rating> [Add to Learning Plan]

[Add all to learning Plan]

@Amy: Button pressed—Add all to Learning Plan

@sfbot: These courses are added to your learning plan.
(f) Example employee use case for recording time and attendance based on attended “ToDo” courses

@Amy: ToDos

@sfbot: Hi Amy, You have 2 Instructor Led Trainings due this week, do you want to enroll for the next open Classroom Sessions for them?

[Enroll for “ILT-001”] [Enroll for “ILT-002”] [Enroll for all pending ILTs] [Later] (Buttons)

@Amy: Button pressed—Enroll for all pending ILTs

@sfbot: You are enrolled into the upcoming sessions.

@sfbot: Do you want to record time for these sessions under Further Education

[Record Time as Further Education] [Later]

@Amy: Button pressed—Record Time as Further Education

@sfbot: The session time has been recorded under Further Education

@sfbot: There is also 1 online course due and 1 Survey, you can catch up in 30 minutes. Do you want to launch the course now?

[Launch Course] [Launch Survey] [Later] (Buttons)

@Amy: Button pressed—Launch Course

@sfbot: Launches Course (Action)

@sfbot: Do you want to record time for this course under Further Education

[Record Time as Further Education]—[Later]

@Amy: Button pressed—Record Time as Further Education

@sfbot: The session time has been recorded under Further Education
(g) Example employer use case for enrolling employees in “ToDo” courses

@Carla: Approvals

@sfbot: Hi Carla, You have 1 approval request from Amy and 1 approval request from John. Both have requested to enroll for “Basic Analytics”.

[Approve Basic Analytics for Amy][Approve Basic Analytics for John][Approve All]

[Deny Basic Analytics for Amy][Deny Basic Analytics for John][Deny All]

[Later]

@Carla: Button Pressed—Approve All

@sfbot: Would you like to enroll Smith (direct report with the same job code) for Basic Analytics. He also has analytics related courses in his learning plan and does not have any schedule conflicts?

[Enroll Smith for Basic Analytics][Skip]

@Carla: Button pressed—Enroll Smith for Basic Analytics

@sfbot: Smith is enrolled for Basic Analytics.
(h) Example employer use case for searching for and assigning employees or self to “ToDo” courses

@Carla: I want to learn about Analytics.

@sfbot: “Analytics Simplified” is the highest rated and most popular course on Analytics. You can

[Add to Learning Plan] [Launch Course Now] [View Details] [Show more courses] (These are buttons)

@Carla: Button Clicked—Launch Course Now

@sfbot: Action—Course Launched

@Carla: Good course, everyone should learn this

@sfbot: Do you want to assign this course to all your team members?

[Assign to team members]

@Carla: Button Clicked—Assign to team members

@sfbot: [Assign to Amy] [Assign to John] [Assign to Smith] [Assign to All]

@Carla: Button Pressed—Assign to All

@sfbot: Analytics Simplified has been assigned to all your team members
(i) Example employer use case for searching for and assigning employees to “ToDo” courses

@Carla: Courses on Analytics.

@sfbot: “Analytics Simplified” is the highest rated and most popular course on Analytics. You can

[Add to Learning Plan] [Launch Course Now] [View Details] [Show more courses]

[Assign to team members]

@Carla: Button Clicked—Assign to team members

@sfbot: [Assign to Amy] [Assign to John] [Assign to Smith] [Assign to All]

@Carla: Button Pressed—Assign to All

@sfbot: Analytics Simplified has been assigned to all your team members

@sfbot: Some of your team members have unmet pre-requisites, do you want to assign the unmet pre-requisite courses to them as well?

[Assign unmet Pre-requisites to all team members] [Will review Later]

@Carla: Button Clicked—Assign unmet Pre-requisites to all team members

@sfbot: All the unmet pre-requisites are assigned to your team members
(j) Example employer use case managing self or employee assignments to “ToDo” courses

@Carla: Overdue learning

@sfbot: Congratulations! You do not have anything overdue. Some of your team members have a few overdue items. Do you want to review your team's overdue status?

[Review Overdue Items of the team] [Skip]

@Carla: Button pressed—Review Overdue Items of the team

@sfbot: John has an overdue item—Course 121 that is overdue by 2 weeks. However there is no session scheduled till next month. Do you want to enroll him to the next available session and/or modify the due date?

[Enroll John to the next available session for Course 121][Defer the due date by 2 months] [Change to specific due date]

@Carla: Button Pressed—Defer the due date by 2 months

@sfbot: Assignment of Course 121 for John has been updated and the required date has been changed to <new Date>
(k) Example employer use case for assigning “ToDo” courses to self and successors

@Carla: I want to learn about Analytics.

@sfbot: “Analytics Simplified” is the highest rated and most popular course on Analytics. You can

[Add to Learning Plan] [Launch Course Now] [View Details] [Show more courses] (These are buttons)

@Carla: Button Clicked—Launch Course Now

@sfbot: Action—Course Launched

@Carla: Good course, everyone should learn this

@sfbot: Do you want to assign this course to your Successors?

[Assign to Successors]

@Carla: Button Clicked—Assign to Successors

@sfbot: [Assign to Amy] [Assign to John] [Assign to All]

@Carla: Button Pressed—Assign to All

@sfbot: Analytics Simplified has been assigned to all your Successors

B. Performing Tasks (Actions) in the System and Interfacing with APIs
(a) Example employee use case for tasks and interfacing with APIs

Employee: What is due today?

CHAT ASSISTANT: Prioritized list of overdue items

Actions—Launch Course/Survey

API—Learning Plan API

EMPLOYEE: Course on a “Topic”/Related to a Goal/Based on Development Plan

CHAT ASSISTANT: List of Courses on the topic

Actions: Add to Learning Plan

API: Catalog Search, Learning Item Assignment

EMPLOYEE: What are the pre-requisites?

CHAT ASSISTANT: List of Pre-requisites

Actions: Add Pre-requisites to Learning Plan

API: Learning Item Pre-requisites, Learning Item Assignment

EMPLOYEE: List of sessions for this course

CHAT ASSISTANT: List of Open Scheduled Offerings for the Item in the region of the User

Actions—Enroll

API: Get Scheduled Offering API, Enroll into Scheduled Offerings

EMPLOYEE: Enroll into Scheduled Offerings for Over Due Items

CHAT ASSISTANT: Proposed list of earliest Scheduled Offerings available in the region considering prerequisites

Actions: Enroll/Enroll into All

API: Get Scheduled Offering API, Enroll into Scheduled Offerings

Context: User busy/On Leave this week

EMPLOYEE: Withdraw from Scheduled Offerings

CHAT ASSISTANT: Withdraw User from Scheduled Offerings during the specified period

API: Modify Enrollment Status
(b) Example employer use case for basic tasks and interfacing with APIs

MANAGER: Is there something I need to approve?

CHAT ASSISTANT: List of Learning Approvals

Actions—Approve, Approve All, Deny

API: Learning Approval Web services

MANAGER: Course on a “Topic”

CHAT ASSISTANT: List of Courses on the topic

Actions: Add to Learning Plan, Assign Course to Team member, Assign course to All direct reports.

API: Catalog Search, Learning Item Assignment

MANAGER: What is overdue for my team?

CHAT ASSISTANT: List of Overdue Items for the team

Actions: Modify Assignment

API: Learning Item Assignment

### ADDITIONAL ALTERNATIVE EMBODIMENTS

One or more aspects or features of the subject matter described herein can be realized in digital electronic circuitry, integrated circuitry, specially designed application specific integrated circuits (ASICs), field programmable gate arrays (FPGAs), computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, can include machine instructions for a programmable processor, and/or can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, solid-state storage devices, memory, and Programmable Logic Devices (PLDs), used to provide machine instructions and/or data to a programmable data processor, including a machine-readable medium that receives machine instructions as a computer-readable signal. The term “computer-readable signal” refers to any signal used to provide machine instructions and/or data to a programmable data processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, such as for example as would a processor cache or other random access memory associated with one or more physical processor cores.

The computer components, software modules, functions, data stores and data structures described herein can be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality can be located on a single computer or distributed across multiple computers depending upon the situation at hand.

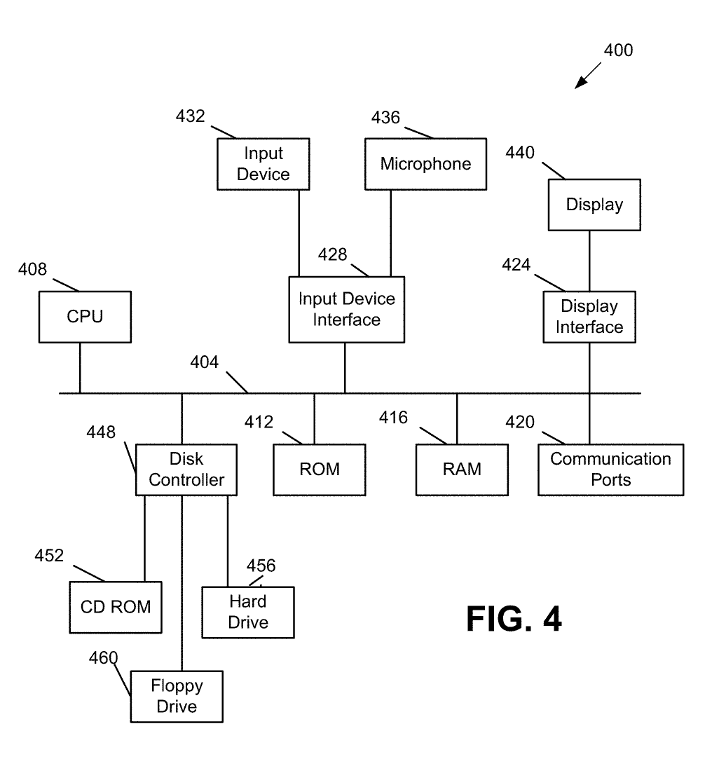

FIG. 4 is a diagram 400 illustrating a sample computing device architecture for implementing various aspects described herein, such as any aspect that can be processed using server(s) 140, client device(s) 110 or 110′, or processing system 150 executing automated intelligent assistant 151 or APIs 152 . . . 154. A bus 404 can serve as the information highway interconnecting the other illustrated components of the hardware. A processing system 408 labeled CPU (central processing unit) (e.g., one or more computer processors/data processors at a given computer or at multiple computers), can perform calculations and logic operations required to execute a program. A non-transitory processor-readable storage medium, such as read only memory (ROM) 412 and random access memory (RAM or buffer) 416, can be in communication with the processing system 408 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 448 can interface one or more optional disk drives to the system bus 404. These disk drives can be external or internal floppy disk drives such as 460, external or internal CD-ROM, CD-R, CD-RW or DVD, or solid state drives such as 452, or external or internal hard drives 456. As indicated previously, these various disk drives 452, 456, 460 and disk controllers are optional devices. The system bus 404 can also include at least one communication port 420 to allow for communication with external devices either physically connected to the computing system or available externally through a wired or wireless network. In some cases, the communication port 420 includes or otherwise comprises a network interface.

To provide for interaction with a user, the subject matter described herein can be implemented on a computing device having a display device 440 (e.g., a CRT (cathode ray tube) or LCD (liquid crystal display) monitor) for displaying information obtained from the bus 404 to the user and an input device 432 such as keyboard and/or a pointing device (e.g., a mouse or a trackball) and/or a touchscreen by which the user can provide input to the computer. Other kinds of input devices 432 can be used to provide for interaction with a user as well; for example, feedback provided to the user can be any form of sensory feedback (e.g., visual feedback, auditory feedback by way of a microphone 436, or tactile feedback); and input from the user can be received in any form, including acoustic, speech, or tactile input. In the input device 432 and the microphone 436 can be coupled to and convey information via the bus 404 by way of an input device interface 428. Other computing devices, such as dedicated servers, can omit one or more of the display 440 and display interface 424, the input device 432, the microphone 436, and input device interface 428.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, by an automated intelligent assistant operating on one or more data processors, first user input comprising free-form text entered into a user interface (UI) forming part of an end-user layer of a computer system;
parsing, by the automated intelligent assistant, the free-form text to identify an intent of the user, wherein the intent is selected from a group of pre-defined intents, wherein the group of pre-defined intents comprises requests for employee data, requests for employer data, and requests for execution of tasks relating to employment of the employee by the employer;
deploying, by the automated intelligent assistant, an extensible markup language (XML) file corresponding to the identified intent, wherein the XML file defines a parameter required for implementation of that intent and an application program interface (API) required for implementation of that intent, wherein the deploying comprises:
prompting, by the automated intelligent assistant, the user to enter the parameter defined by the XML file into the UI;
calling the API defined by the XML file;
passing the entered parameter to the called API; and
receiving an output from the called API responsive to the entered parameter; and
generating, by the automated intelligent assistant, a response to the identified intent of the user based on the output from the called API.

2. The method of claim 1, wherein the parsing comprises identifying a keyword in the free-form text that corresponds to the identified intent.

3. The method of claim 1, wherein the prompting comprises conversationally posing a question to the user within the UI, and wherein the entered parameter comprises free-form text.

4. The method of claim 1, wherein the prompting comprises presenting to the user a plurality of choices within the UI, and wherein the entered parameter comprises a selected one of the choices.

5. The method of claim 1, wherein the employee data and employer data are stored in one or more databases of the computer system.

6. The method of claim 5, wherein the intent comprises a request for employee data or employer data, and wherein the API extracts the requested employee data or employer data from the one or more databases responsive to the entered parameter.

7. The method of claim 1, wherein the intent comprises a request for execution of a task relating to employment of the employee by the employer, and wherein the API executes the task responsive to the entered parameter.

8. A computer system comprising:
at least one data processor; and
memory storing instructions which, when executed by the at least one data processor, result in operations comprising:
receiving, by an automated intelligent assistant operating on one or more data processors, first user input comprising free-form text entered into a user interface (UI) forming part of an end-user layer of a computer system;
parsing, by the automated intelligent assistant, the free-form text to identify an intent of the user, wherein the intent is selected from a group of pre-defined intents, wherein the group of pre-defined intents comprises requests for employee data, requests for employer data, and requests for execution of tasks relating to employment of the employee by the employer;
deploying, by the automated intelligent assistant, an extensible markup language (XML) file corresponding to the identified intent, wherein the XML file defines a parameter required for implementation of that intent and an application program interface (API) required for implementation of that intent, wherein the deploying comprises:
prompting, by the automated intelligent assistant, the user to enter the parameter defined by the XML file into the UI;
calling the API defined by the XML file;
passing the entered parameter to the called API; and
receiving an output from the called API responsive to the entered parameter; and
generating, by the automated intelligent assistant, a response to the identified intent of the user based on the output from the called API.

9. The computer system of claim 8, wherein the parsing comprises identifying a keyword in the free-form text that corresponds to the identified intent.

10. The computer system of claim 8, wherein the prompting comprises conversationally posing a question to the user within the UI, and wherein the entered parameter comprises free-form text.

11. The computer system of claim 8, wherein the prompting comprises presenting to the user a plurality of choices within the UI, and wherein the entered parameter comprises a selected one of the choices.

12. The computer system of claim 8, wherein the employee data and employer data are stored in one or more databases of the computer system.

13. The computer system of claim 12, wherein the intent comprises a request for employee data or employer data, and wherein the API extracts the requested employee data or employer data from the one or more databases responsive to the entered parameter.

14. The computer system of claim 1, wherein the intent comprises a request for execution of a task relating to employment of the employee by the employer, and wherein the API executes the task responsive to the entered parameter.

15. A non-transitory computer-readable medium storing instructions which, when executed by at least one data processor of a computer system, result in operations comprising:
receiving, by an automated intelligent assistant operating on one or more data processors, first user input comprising free-form text entered into a user interface (UI) forming part of an end-user layer of a computer system;
parsing, by the automated intelligent assistant, the free-form text to identify an intent of the user, wherein the intent is selected from a group of pre-defined intents, wherein the group of pre-defined intents comprises requests for employee data, requests for employer data, and requests for execution of tasks relating to employment of the employee by the employer;
deploying, by the automated intelligent assistant, an extensible markup language (XML) file corresponding to the identified intent, wherein the XML file defines a parameter required for implementation of that intent and an application program interface (API) required for implementation of that intent, wherein the deploying comprises:
prompting, by the automated intelligent assistant, the user to enter the parameter defined by the XML file into the UI;
calling the API defined by the XML file;
passing the entered parameter to the called API; and
receiving an output from the called API responsive to the entered parameter; and
generating, by the automated intelligent assistant, a response to the identified intent of the user based on the output from the called API.

16. The computer readable medium of claim 15, wherein the parsing comprises identifying a keyword in the free-form text that corresponds to the identified intent.

17. The computer readable medium of claim 15, wherein the prompting comprises conversationally posing a question to the user within the UI, and wherein the entered parameter comprises free-form text.

18. The computer readable medium of claim 15, wherein the prompting comprises presenting to the user a plurality of choices within the UI, and wherein the entered parameter comprises a selected one of the choices.

19. The computer readable medium of claim 15, wherein the employee data and employer data are stored in one or more databases of the computer system,
wherein the intent comprises a request for employee data or employer data, and
wherein the API extracts the requested employee data or employer data from the one or more databases responsive to the entered parameter.

20. The computer readable medium of claim 15, wherein the intent comprises a request for execution of a task relating to employment of the employee by the employer, and wherein the API executes the task responsive to the entered parameter.
